(19) United States
(12) Patent Application Publication
(10) Pub. No.: US 2011/0183025 A1
(43) Pub. Date: Jul. 28, 2011

(54) SCOOP INCORPORATING A HEAT TRANSFER FLUID

(76) Inventor: Thomas M. Funka, JR., Vero Beach, FL (US)

(21) Appl. No.: 13/013,523

(22) Filed: Jan. 25, 2011

Related U.S. Application Data
(60) Provisional application No. 61/297,932, filed on Jan. 25, 2010.

(51) Int. Cl. A23G 9/28; B29C 65/48

(52) U.S. Cl. 425/279; 156/145

(57) ABSTRACT

A dishwasher safe ice cream scoop is disclosed, the ice cream scoop including a scoop bowl, a handle extending laterally outwardly from connected to the scoop bowl, the handle having a cavity formed therein, a heat transfer fluid disposed in the cavity of the handle, a cap joined with the handle and adapted to seal the cavity of the handle, and a coating formed on at least one of the scoop bowl and the handle to militate against at least one of oxidation, corrosion, and tarnishing.

### CROSS-REFERENCE TO RELATED APPLICATION

This application claims the benefit of priority of U.S. Provisional Patent Application Ser. No. 61/297,932 filed on Jan. 25, 2010 hereby incorporated herein by reference in its entirety.

### FIELD OF THE INVENTION

The invention relates to ice cream scoops, and more particularly to an ice cream scoop having a heat transfer fluid contained therein.

### BACKGROUND OF THE INVENTION

Using scoops, spades, and spoons, ice cream is commonly transferred from a storage container to a serving dish or a cone. Since ice cream is stored at below-freezing temperatures, the contents become hard packed requiring a significant force to remove a serving of ice cream from the storage container. Some individuals may be unable to apply the required force. Furthermore, the ice cream often adheres to the scoop after separation from the storage container, making it difficult to release the ice cream from an ice cream scoop to the serving dish or the cone.

Scoops may be warmed prior to use to facilitate the function of the scoop. The scoop then conducts thermal energy to the ice cream with which it comes in contact, thereby softening or slightly melting the ice cream. The force needed to cut through and remove the serving of softened ice cream is thus reduced. Additionally, the ice cream is less likely to adhere to the scoop and is easier to transfer to a serving dish or the cone.

While the foregoing method may be effective, heated water containers often are used to warm several scoops simultaneously, thereby creating unsanitary and aesthetically unattractive conditions. In addition, there is a risk of contamination when a scoop transfers unsanitary water to the ice cream within the storage container. Furthermore, the scoop must frequently be returned to the container containing the heated water to maintain an elevated temperature of the scoop, thereby prolonging the time and effort required to prepare an ice cream serving.

Previously known methods and apparatus have been proposed for serving ice cream that seek to obtain the benefits derived from elevating the temperature of an ice cream scoop without suffering the frequent heating delays and risk of contamination associated with heated water baths. For example, U.S. Pat. No. 5,837,296 to Virkler describes a hollow scoop with a removable cap that facilitates filling the scoop with warm tap water before use. The device described may be effective for short-term use; however, the apparatus is expected to be able to sustain an elevated temperature for only relatively short periods of time before the warm water inside the scoop cools, and requires repetitive replacement of heated water.

Several commercially available scoops seal a quantity of water or antifreeze within a hollow handled scoop, so that the sealed liquid acts as a heat sink to conduct heat energy to the scoop portion of the utensil. However, such scoops are not dishwasher safe. The elevated temperatures at which dishwashers operate and the abrasive dishwasher detergents contribute to the tarnishing of any metal portions of the scoops. Furthermore, the elevated temperatures of the dishwasher may cause the antifreeze to thermally expand and escape from the scoop, thereby diminishing the usefulness of the scoop. Therefore, such antifreeze containing scoops must be hand washed.

U.S. Pat. No. 3,809,520 to Wilk describes an ice cream scoop with an interior fluid circulation passage that may be connected to a faucet. Warm water is continuously circulated through the interior of the scoop so that the cutting surface of the scoop remains heated. While the scoop of Wilk may be effective, the device has a limited range since it must remain connected to a warm water source. It is also thermally and ecologically inefficient because the warm water is disposed of after it has passed through the interior passage once.

Electrical resistive heating has also been proposed as a means of elevating ice cream scoop temperature. For example, U.S. Pat. No. 3,992,604 to Leddy, U.S. Pat. No. 4,386,900 to Sultan, and U.S. Pat. No. 4,553,921 to Lamphere describe scoops with heating elements that are connected to a remote source of electrical energy. The utility of such scoops is limited by the length of the attached power cords used to supply the electrical energy. Furthermore, such designs pose an inherent risk of electrocution, especially in the fluid environments provided by melted ice cream and during cleaning.

U.S. Pat. No. 5,000,672 to Halimi describes a system which attempts to overcome some of the drawbacks of AC voltage heated scoops by using batteries as the source of electrical power. A resistive wire is attached along the cutting edge of the scoop. The scoop is actively heated only along the wire, thereby minimizing the heated volume and reducing the power drain on the batteries. Thermodynamic modeling of the device of Halimi has revealed that the remainder of the scoop bowl acts as a heat sink which actually conducts heat away from the cutting surface. Thus, for example, if the scoop bowl is metal, maintaining an adequate elevated temperature at the cutting surface for any significant length of time is expected to require more energy than is typically available from standard batteries. Alternatively, use of a plastic scoop bowl may result in melting of the plastic or thermal and mechanical fatigue problems.

Other heating methods also have been proposed. For example, U.S. Pat. No. 5,131,832 to Budreau discloses a butane heating cartridge or a standard lighter as the energy source. Since the fuel must be ignited, a risk of fire or skin burns exists, as well as melting of the ice cream due to overheating. In short, several methods for heating an ice cream scoop have been proposed, but all of these methods suffer from shortcomings that have limited or prevented widespread adoption in the marketplace.

In view of the foregoing, it would be desirable to provide an apparatus for serving frozen products that overcomes the disadvantages of previously known devices. Specifically, it would be desirable to provide a safe, sanitary, effective, dishwasher safe ice cream scoop adapted for serving frozen products in both commercial and residential settings.

### SUMMARY OF THE INVENTION

Concordant and congruous with the present invention, a safe, sanitary, effective, dishwasher safe ice cream scoop adapted for serving frozen products in both commercial and residential settings has surprisingly been discovered.

In an embodiment of the invention, An ice cream scoop comprises a scoop bowl; a handle extending laterally outwardly from connected to the scoop bowl, the handle having a cavity formed therein; a heat transfer fluid disposed in the cavity of the handle; a cap joined with the handle and adapted to seal the cavity of the handle; and a coating formed on at least one of the scoop bowl and the handle to militate against at least one of oxidation, corrosion, and tarnishing.

In another embodiment of the invention, a method of assembling an ice cream scoop comprises the steps of providing an ice cream scoop having a scoop bowl and a handle extending laterally outwardly from the scoop bowl, the handle having a cavity formed therein adapted to receive a heat transfer fluid; coating at least one of the scoop bowl and the hollow handle with a coating to militate against at least one of oxidation, corrosion, and tarnishing; introducing a heat transfer fluid into the cavity; disposing an expansion plug in the cavity; and introducing a force onto the expansion plug to cause the plug to form a fluid tight seal with the handle.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of the ice cream scoop according to an embodiment of invention;

FIG. 2 is a side elevational view of an end cap of the ice cream scoop shown in FIG. 1;

FIG. 3 is a side elevational view partially shown in section of the ice cream scoop of FIG. 1;

FIG. 4 is a side elevational cross-sectional view partially shown in section of an ice cream scoop having an unsealed expansion plug according to an embodiment of the invention;

FIG. 5 is a side elevational view partially shown in section of the ice cream scoop of FIG. 4 with a sealed expansion plug;

FIG. 6 is a side elevational view partially shown in section of the ice cream scoop of with a sealed expansion plug according to another embodiment of the invention; and

FIG. 7 is a side elevational view partially shown in section of the ice cream scoop of with a sealed expansion plug according to another embodiment of the invention.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

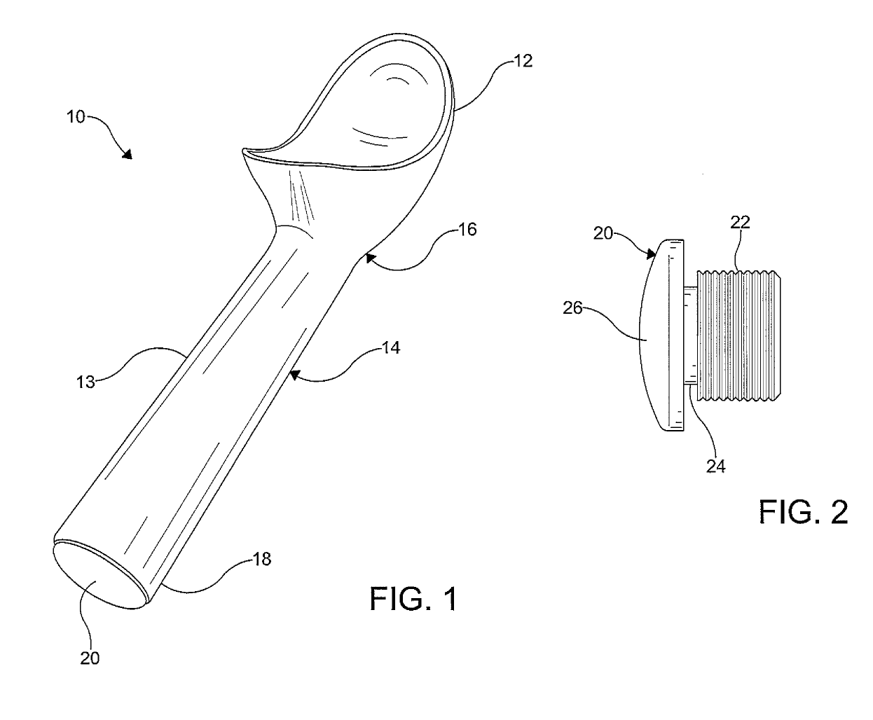

FIG. 1 shows a dishwasher safe ice cream scoop 10 having a scoop bowl 12 and an associated handle 14 according to an embodiment of the invention. The scoop bowl 12 and the handle 14 are formed from a metal, such as a stainless steel or aluminum, for example. However, it will be understood that the scoop bowl 12 and the handle 14 may be formed from any resilient material, such as a plastic, for example, as desired. As shown, the scoop bowl 12 and the handle 14 are formed seamlessly together. However, the scoop bowl 12 and the handle 14 may be separately formed and fixed together by one of a friction fit, an adhesive, soldering, welding, or the like.

The scoop bowl 12 of the ice cream scoop 10 has a generally u-shaped cross-section and forms a generally concave hemispherical cavity. The scoop bowl 12 may be hollow, forming an internal cavity (not shown) in fluid communication with a cavity 21 formed in the handle 14 or the scoop bowl 12 may be formed from a solid material. The scoop bowl 12 and/or the handle 14 includes a coating 13 adapted to militate against oxidation, corrosion, and/or tarnishing of the material forming the scoop bowl 12. The coating 13 may be a polytetrafluoroethylene (PTFE) coating, a perfluorooctanoic acid (PFOA) coating, an anodized coating, such as an anodized aluminum coating or an anodized titanium coating, for example, an anodized coating free from heavy metals (e.g. hexavalent chromium, cadmium, lead, etc.), such as the coatings sold under the trademark EnduraGuard™ and the trademark CastGuard™ sold by Pioneer Metal Finishing of Green Bay, Wis., for example. The ice cream scoop 10 may also include a second coating (not shown), such as an anodized coating pre-treated prior to the anodizing process to obtain a pre-anodizing coating having a frosted appearance, such as the pre-anodizing coating sold under the trademark FrostKote™ sold by Pioneer Metal Finishing. Alternatively, the coating 13 of the scoop bowl 12 and/or the handle 14 may be an electroless plating applied using an electroless plating process. The electroless plating may be an electroless nickel plating formed from at least one of a layer of nickel-phosphorus and a nickel-boron alloy. The alloys may have different percentages of phosphorus, ranging from about 2-5% (low phosphorus) to about 11-14% (high phosphorus). Electroless plating, unlike electroplating, provides an even deposit of the plating layer on the ice cream scoop 10, and, with a proper pre-plate catalyst, call deposit on non-conductive surfaces. Furthermore, the electroless plating may form a matte, semi-gloss, or gloss finish on the ice cream scoop 10.

The handle 14 has a proximal end 16 adjacent the scoop bowl 12 and a distal end 18. An opening 23 adapted to receive an end cap 20 is formed in the distal end 18. The handle 14 is hollow and forms the cavity 21 adapted to receive a heat transfer fluid 25. The heat transfer fluid 25 acts as a heat sink that absorbs and dissipates heat when the ice cream scoop 10 is in use. Propylene glycol is a suitable heat transfer fluid that facilitates the cleaning of the ice cream scoop 10 in a dishwasher. Propylene glycol, unlike other heat transfer fluids such as ethylene glycol, can withstand the temperatures and pressures within a typical residential or commercial dishwasher without substantially thermally expanding and leaking from the ice cream scoop 10. Typical high temperatures within dishwashers are between about 130° F. and about 150° F. or above.

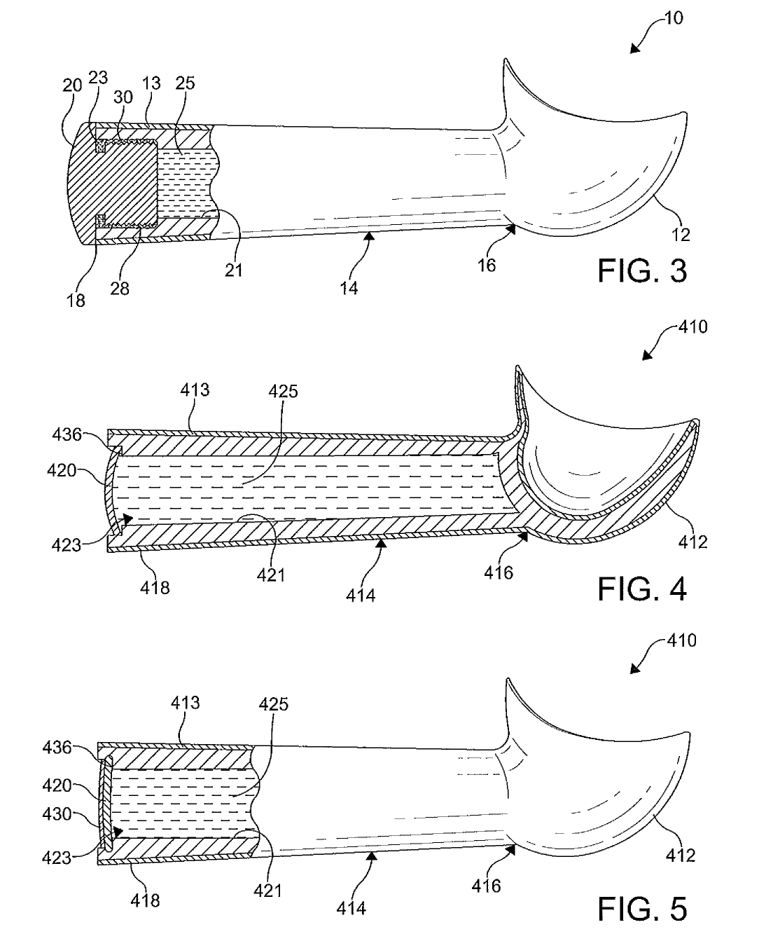

As best shown in FIGS. 2 and 3, the end cap 20 includes threads 22 adapted to cooperate with threads 28 formed on an interior of the handle 14 adjacent the opening 23. The end cap 20 further includes an annular groove 24 formed between the threads 22 and an end 26 of the end cap 20. It is understood that the handle 14 and the end cap 20 may include any mechanical means for coupling the end cap 20 to the handle 14, such as detents and protuberances and indents, for example. A fluid tight seal is formed between the end cap 20 and the handle 14. To ensure a fluid tight seal between the handle 14 and the end cap 20, an expandable adhesive 30 may be disposed on the threads 22 of the end cap 20 or the threads 28 of the handle 14. The expandable adhesive 30 may also be disposed on the annular groove 24. The expandable adhesive 30 may be any suitable adhesive adapted to expand, such as an epoxy, for example. A suitable epoxy includes the epoxy sold by ND Industries under the trademark Expand-a-Seal® ES0105.

To assemble the ice cream scoop 10, the scoop bowl 12 and the handle 14 are formed. The scoop bowl 12 and/or the handle 14 may be coated or electrolessly plated prior to assembly of the ice cream scoop 10 or after, as desired. The heat transfer fluid 25 is then introduced into the cavity 21 of the handle 14 and the scoop bowl 12, if the scoop bowl 12 is also hollow. The heat transfer fluid 25 may substantially fill the cavity 21, or a portion of the cavity 21 may remain empty to allow for thermal expansion of the heat transfer fluid 25. The expandable adhesive 30 is then disposed on the end cap 20. The expandable adhesive 30 is disposed on the threads 22, on the threads 28, in the annular groove 24, or a combination thereof. The end cap 20 is then screwed into the handle 14 to seal the heat transfer fluid 25 therein. The expandable adhesive 30 is allowed to cure and expand therein and substantially fill any void space between the threads 22 and the annular groove 24 and an interior of the handle 14. Once the expandable adhesive 30 is allowed to cure, a fluid tight seal is formed. The fluid tight seal militates against the leaking of the heat transfer fluid 25 from the handle 14, thereby allowing the ice cream scoop 10 to be washed in a dishwasher. Furthermore, by including the coating 13 on the scoop bowl 12 and/or the handle 14 of the ice cream scoop 10, oxidation, corrosion, and tarnishing thereof is minimized, thereby allowing the ice cream scoop to be cleaned in a dishwasher unlike metal ice cream scoops known in the art.

FIGS. 4 and 5 show a dishwasher safe ice cream scoop 410 having a scoop bowl 412 and an associated handle 414 according to another embodiment of the invention. The scoop bowl 412 and the handle 414 are formed from a metal, such as a stainless steel or aluminum, for example. However, it will be understood that the scoop bowl 412 and the handle 414 may be formed from any resilient material, such as a plastic, for example, as desired. As shown, the scoop bowl 412 and the handle 414 are formed seamlessly together. However, the scoop bowl 412 and the handle 414 may be separately formed and fixed together by one a friction fit, an adhesive, soldering, welding, or the like.

The scoop bowl 412 of the ice cream scoop 410 has a generally u-shaped cross-section and forms a generally concave hemispherical cavity. The scoop bowl 412 may be hollow, forming an internal cavity (not shown) in fluid communication with a cavity 421 formed in the handle 414. The scoop bowl 412 and/or the handle 414 includes a coating 413 adapted to militate against oxidation, corrosion, and/or tarnishing of the material forming the scoop bowl 412. The coating 413 may be a polytetrafluoroethylene (PTFE) coating, a perfluorooctanoie acid (PFOA) coating, an anodized coating, such as an anodized aluminum coating or an anodized titanium coating, for example, an anodized coating free from heavy metals (e.g. hexavalent chromium, cadmium, lead, etc.), such as the coatings sold under the trademark EnduraGuard™ and the trademark CastGuard™ sold by Pioneer Metal Finishing of Green Bay, Wis., for example. The ice cream scoop 410 may also include a second coating (not shown), such as an anodized coating pre-treated prior to the anodizing process to obtain a pre-anodizing coating having a frosted appearance, such as the pre-anodizing coating sold under the trademark FrostKote™ sold by Pioneer Metal Finishing. Alternatively, the scoop bowl 412 and/or the handle 414 may be plated using an electroless plating process. The electroless plating may be an electroless nickel plating formed from at least one of a layer of nickel-phosphorus and a nickel-boron alloy. The alloys may have different percentages of phosphorus, ranging from about 2-5% (low phosphorus) to about 11-14% (high phosphorus). Electroless plating, unlike electroplating, provides an even deposit of the plating layer on the ice cream scoop 410, and, with a proper pre-plate catalyst, can deposit on non-conductive surfaces. Furthermore, the electroless plating may form a matte, semi-gloss, or gloss finish on the ice cream scoop 410.

The handle 414 has a proximal end 416 adjacent the scoop bowl 412 and a distal end 418. An opening 423 adapted to receive an end cap 420 is formed in the distal end 418. The handle 414 is hollow and forms the cavity 421 adapted to receive a heat transfer fluid 425. The heat transfer fluid 425 acts as a heat sink that absorbs and dissipates heat when the ice cream scoop 410 is in use. Propylene glycol is a suitable heat transfer fluid that facilitates the cleaning of the ice cream scoop 410 in a dishwasher. Propylene glycol, unlike other heat transfer fluids such as ethylene glycol, can withstand the temperatures and pressures within a typical residential or commercial dishwasher without substantially thermally expanding and leaking from the ice cream scoop 410. Typical temperatures within dishwashers are between about 130° F. and about 150° F. or above.

In the embodiment shown in FIGS. 4 and 5, the end cap 420 is an expansion plug formed from metal. It is understood that the end cap 420 may be formed from other deformable materials, as desired. The end cap 420 has a curvilinear cross-section with a concave side thereof facing the cavity 421 of the handle 414.

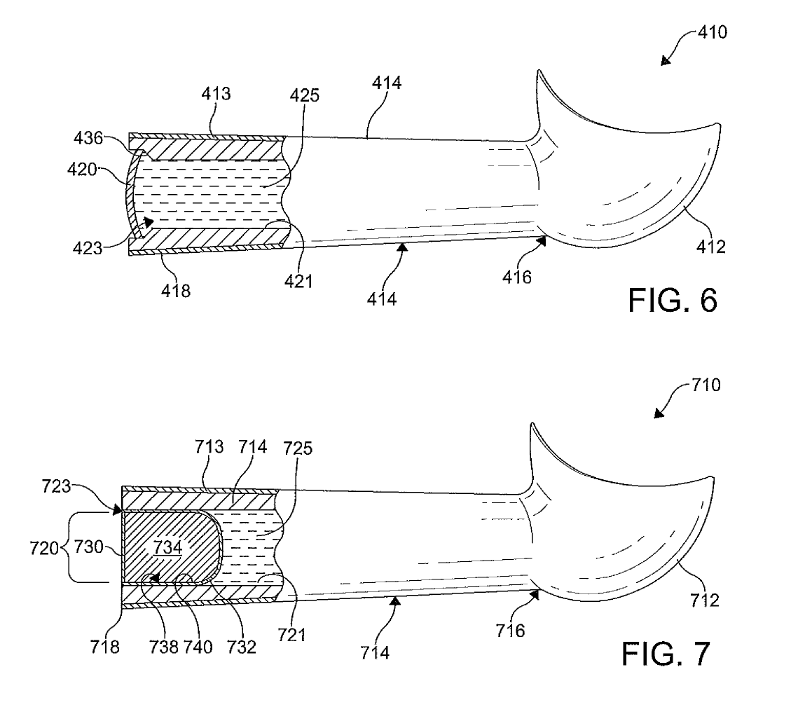

The end cap 420 abuts an annular shoulder 436 formed in an interior wall of the handle 414. The annular shoulder 436 forms an angle of about 90° with respect to the handle 414. As shown in FIG. 6, the annular shoulder 436 may form an angle with respect to the handle 414 greater than 90°, such as an angle between greater than about 90° and about 100°, and preferably at about 96°. To form a fluid tight seal between the handle 414 and the end cap 420, a hydraulic or pneumatic insertion tool is caused to impart a force on a convex side of the end cap 420 to cause the end cap 420 to deform until the end cap 420 to form the fluid tight seal with the interior wall of the handle 414. The fluid tight seal may be created by outer peripheral edges of the end cap 420 imbedding in the interior wall, as shown in FIG. 5, or by the outer peripheral edges deforming and pressing against the interior wall to create the fluid tight seal. Once the force has been imparted on the end cap 420, the end cap 420 may have a substantially linear cross section, a generally concave curvilinear cross section, or a generally convex curvilinear cross section. Additionally, an expandable adhesive 430 may be applied to the end cap 420 to further ensure a fluid tight seal. The fluid tight seal militates against the leaking of the heat transfer fluid 425 from the handle 414, thereby allowing the ice cream scoop 410 to be washed in a dishwasher. The expandable adhesive 430 may be any suitable adhesive adapted to expand, such as an epoxy, for example. A suitable epoxy includes the epoxy sold by ND Industries under the trademark Expand-a-Seal® ES0105.

To assemble the ice cream scoop 410, the scoop bowl 412 and the handle 414 are formed. The scoop bowl 412 and/or the handle 414 may be coated or electrolessly plated prior to assembly of the ice cream scoop 410 or after, as desired. The heat transfer fluid 425 is then introduced into the cavity 421 of the handle 414 and the scoop bowl 412, if the scoop bowl 412 is also hollow. The heat transfer fluid 425 may substantially fill the cavity 421, or a portion of the cavity 421 may remain empty to allow for thermal expansion of the heat transfer fluid 425. The end cap 420 is then disposed in the handle 414 abutting the shoulder 436. A force is applied to the end cap 420 to form a fluid tight seal between the end cap 420 and the handle 414 to seal the heat transfer fluid 425 within the ice cream scoop 410. If desired, a decorative cap (not shown) may be glued or otherwise attached to the handle 414 to cover the end cap 420. Furthermore, by including the coating 413 on the scoop bowl 412 and/or the handle 414 of the ice cream scoop 410, oxidation, corrosion, and tarnishing thereof is minimized, thereby allowing the ice cream scoop to be cleaned in a dishwasher unlike metal ice cream scoops known in the art.

FIG. 7 shows a dishwasher safe ice cream scoop 710 having a scoop bowl 712 and an associated handle 714 according to another embodiment of the invention. The scoop bowl 712 and the handle 714 are formed from a metal, such as a stainless steel or aluminum, for example. However, it will be understood that the scoop bowl 712 and the handle 714 may be formed from any resilient material, such as a plastic, for example, as desired. The scoop bowl 712 and the handle 714 are formed seamlessly together. However, the scoop bowl 712 and the handle 714 may be separately formed and fixed together by one a friction fit, an adhesive, soldering, welding, or the like.

The scoop bowl 712 of the ice cream scoop 710 has a generally u-shaped cross-section and forms a generally concave hemispherical cavity. The scoop bowl 712 may be hollow, forming an internal cavity (not shown) in fluid communication with a cavity 721 formed in the handle 714. The scoop bowl 712 and/or the handle 714 includes a coating 713 adapted to militate against oxidation, corrosion, and/or tarnishing of the material forming the scoop bowl 712. The coating 713 may be a polytetrafluoroethylene (PTFE) coating, a perfluorooctanoic acid (PFOA) coating, an anodized coating, such as an anodized aluminum coating or an anodized titanium coating, for example, an anodized coating free from heavy metals (e.g. hexavalent chromium, cadmium, lead, etc.), such as the coatings sold under the trademark EnduraGuard™ and the trademark CastGuard™ sold by Pioneer Metal Finishing of Green Bay, Wis., for example. The ice cream scoop 710 may also include a second coating (not shown), such as an anodized coating pre-treated prior to the anodizing process to obtain a pre-anodizing coating having a frosted appearance, such as the pre-anodizing coating sold under the trademark FrostKote™ sold by Pioneer Metal Finishing. Alternatively, the scoop bowl 712 and/or the handle 714 may be plated using an electroless plating process. The electroless plating may be an electroless nickel plating formed from at least one of a layer of nickel-phosphorus and a nickel-boron alloy. The alloys may have different percentages of phosphorus, ranging from about 2-5% (low phosphorus) to about 11-14% (high phosphorus). Electroless plating, unlike electroplating, provides an even deposit of the plating layer on the ice cream scoop 710, and, with a proper pre-plate catalyst, can deposit on non-conductive surfaces. Furthermore, the electroless plating may form a matte, semi-gloss, or gloss finish on the ice cream scoop 710.

The handle 714 has a proximal end 716 adjacent the scoop bowl 712 and a distal end 718. An opening 723 adapted to receive an end cap 720 is formed in the distal end 718. The handle 714 is hollow and forms the cavity 721 adapted to receive a heat transfer fluid 725. The heat transfer fluid 725 acts as a heat sink that absorbs and dissipates heat when the ice cream scoop 710 is in use. Propylene glycol is a suitable heat transfer fluid that facilitates the cleaning of the ice cream scoop 710 in a dishwasher. Propylene glycol, unlike other heat transfer fluids such as ethylene glycol, can withstand the temperatures and pressures within a typical residential or commercial dishwasher without substantially thermally expanding and leaking from the ice cream scoop 710. Typical temperatures within dishwashers are between about 130° F. and about 150° F. or above.

In the embodiment shown in FIG. 7, the end cap 720 is an expansion plug formed from an insert 732 and a plug 734. The insert 732 and the plug 734 are formed from metal, but may be formed from other deformable materials, as desired. The insert 732 is fixed to the handle 714 with a friction fit. It is understood that the insert 732 may be fixed to the handle 714 with an adhesive, soldering, welding, or the like. Further, the handle 714 may be formed around the insert 732. If the handle 714 is formed around the insert 732, the insert 732 may include cavities adapted to receive a portion of the material forming the handle 714 to mechanically attach the insert 732 thereto, or the insert 732 may have protuberances formed thereon forming spaces therebetween to receive a portion of the material forming the handle 714. Alternatively, the insert 732 may include threads adapted to cooperate with threads formed on an inner wall of the handle 714. The insert 732 includes a hollow cavity 738 formed therein adapted to receive the plug 734. The hollow cavity 738 is formed by tapered walls 740 of the insert 732. It is understood that the hollow cavity 738 formed in the insert 732 may have any shape, such as a curvilinear shape, a u-shape, a rectangular shape, or a frustoconical shape, for example, as desired. The plug 734 has a shape substantially identical to the shape of the hollow cavity 738 except that the plug 734 is larger than the cavity 738 formed in the insert 732. The plug 734 may be a sphere having a circumference larger than the smallest diameter of the hollow cavity 738 formed by the tapered walls 740, as desired.

To form a fluid tight seal between the handle 714 and the end cap 720, a hydraulic or pneumatic insertion tool is caused to impart a force on the plug 734 to force the plug 734 within the hollow cavity 738. Since the plug 734 is larger than the hollow cavity 738, the force imparted thereon causes the tapered walls 740 and/or the plug 734 to deform to form a fluid tight seal therebetween. Deformation of the hollow cavity 738 by the plug 734 may cause an exterior of the insert 732 to expand and further engage the interior wall of the handle 714. Additionally, an expandable adhesive 730 may be disposed on the tapered walls 740, the plug 734, or a portion of the foregoing to further ensure a fluid tight seal. The fluid tight seal militates against the leaking of the heat transfer fluid 725 from the handle 714, thereby allowing the ice cream scoop 710 to be washed in a dishwasher. The expandable adhesive 730 may be any suitable adhesive adapted to expand, such as an epoxy, for example. A suitable epoxy includes the epoxy sold by ND Industries under the trademark Expand-a-Seal® ES0105.

To assemble the ice cream scoop 710, the scoop bowl 712 and the handle 714 are formed. The scoop bowl 712 and/or the handle 714 may be coated or electrolessly plated prior to assembly of the ice cream scoop 710 or after, as desired. The insert 732 is disposed within the handle 714, abutting the annular shoulder 736. The heat transfer fluid 725 is then introduced into the cavity 721 of the handle 714 and the scoop bowl 712, if the scoop bowl 712 is also hollow, through an aperture 442 formed in the insert 732. The heat transfer fluid 725 may substantially fill the cavity 721, or a portion of the cavity 721 may remain empty to allow for thermal expansion of the heat transfer fluid 725. It is understood that the insert 732 may not include the aperture 732, and that the heat transfer fluid 725 may be introduced into the cavity 721 prior to the insert 732 being disposed in the handle 714. The plug 734 is then disposed in the hollow cavity 738. A force is applied to the plug 734 to cause the tapered walls 740 and/or the plug 734 to deform to form a fluid tight seal therebetween to seal the heat transfer fluid 725 within the ice cream scoop 710. If desired, a decorative cap (not shown) may be glued or otherwise attached to the handle 714 to cover the end cap 720. Furthermore, by including the coating 713 on the scoop bowl 712 and/or the handle 714 of the ice cream scoop 710, oxidation, corrosion, and tarnishing thereof is minimized, thereby allowing the ice cream scoop to be cleaned in a dishwasher unlike metal ice cream scoops known in the art.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. An ice cream scoop comprising:
a scoop bowl;
a handle extending laterally outwardly from connected to the scoop bowl, the handle having a cavity formed therein;
a heat transfer fluid disposed in the cavity of the handle;
a cap joined with the handle and adapted to seal the cavity of the handle; and
a coating formed on at least one of the scoop bowl and the handle to militate against at least one of oxidation, corrosion, and tarnishing.

2. The ice cream scoop of claim 1, further comprising an expandable adhesive disposed between the cap and the handle to form a fluid tight seal therebetween.

3. The ice cream scoop of claim 1, wherein the cap is threaded and cooperates with associated threads formed in the handle.

4. The ice cream scoop of claim 3, wherein an expandable adhesive is disposed on the threads of the cap.

5. The ice cream scoop of claim 3, wherein the cap includes an annular groove between an end thereof and the threads.

6. The ice cream scoop of claim 5, wherein an expandable adhesive is disposed in the annular groove of the cap.

7. The ice cream scoop of claim 1, wherein the coating is one of polytetrafluoroethylene (PTFE), perfluorooctanoic acid (PFOA), an anodized coating, and an anodized coating free from heavy metals.

8. The ice cream scoop of claim 7, further comprising a second coating having a frosted appearance applied prior to an anodized coating.

9. The ice cream scoop of claim 1, wherein the cap is an expansion plug.

10. The ice cream scoop of claim 9, wherein the cap has a curvilinear cross-section.

11. The ice cream scoop of claim 9, wherein the cap includes an insert and a plug.

12. The ice cream scoop of claim 11, wherein the insert of the cap forms a hollow cavity for receiving the plug, the plug forming a fluid tight seal with the insert when disposed in the hollow cavity.

13. The ice cream scoop of claim 12, wherein the hollow cavity has a frustoconical shape

14. The ice cream scoop of claim 13, wherein the plug of the cap has a shape substantially identical to but larger than the shape of the hollow cavity.

15. The ice cream scoop of claim 9, further comprising an expandable adhesive disposed on one of the insert and the plug.

16. The ice cream scoop of claim 9, wherein the plug is a sphere.

17. The ice cream scoop of claim 9, further comprising an expandable adhesive disposed between on cap.

18. The ice cream scoop of claim 1, wherein the heat transfer fluid is propylene glycol.

19. A method of assembling an ice cream scoop comprising the steps of:
providing an ice cream scoop having a scoop bowl and a handle extending laterally outwardly from the scoop bowl, the handle having a cavity formed therein adapted to receive a heat transfer fluid;
coating at least one of the scoop bowl and the hollow handle with a coating to militate against at least one of oxidation, corrosion, and tarnishing;
introducing a heat transfer fluid into the cavity;
disposing an expansion plug in the cavity; and
introducing a force onto the expansion plug to cause the plug to form a fluid tight seal with the handle.

20. The method of claim 19, further comprising the step of applying an expandable adhesive to the expansion plug after the fluid tight seal is formed.
